(19) United States
(12) Patent Application Publication
(10) Pub. No.: US 2017/0013883 A1
(43) Pub. Date: Jan. 19, 2017

(54) ELECTRONIC CIGARETTE, DATA PROCESSING APPARATUS, METHOD FOR MEASURING SMOKING AMOUNT AND SMOKING MANAGEMENT SYSTEM EMPLOYING THE SAME

(71) Applicant: INDUSTRY-ACADEMIC COOPERATION FOUNDATION, YONSEI UNIVERSITY, Seoul (KR)

(72) Inventors: Gunhee HAN, Incheon (KR); Seungyup LEE, Seoul (KR)

(73) Assignee: INDUSTRY-ACADEMIC COOPERATION FOUNDATION, YONSEI UNIVERSITY, Seoul (KR)

(21) Appl. No.: 15/211,282

(22) Filed: Jul. 15, 2016

(30) Foreign Application Priority Data
Jul. 15, 2015 (KR) 10-2015-0100424

(51) Int. Cl. A24F 47/00; H04L 29/08; G06F 1/26

(52) U.S. Cl. CPC A24F 47/008; G06F 1/266; H04L 67/06

(57) ABSTRACT

Disclosed are an electronic cigarette, a data processing apparatus, a method for measuring a smoking amount, and a smoking management system using the same. The electronic cigarette may comprise: a power unit to supply power, a liquid container to contain liquid, a heater to generate heat using power supplied from the power unit to evaporate the liquid contained in the liquid container, a sensor unit including a current sensor to measure a current supplied to the heater, a controller to collect information measured by the sensor unit, and a communication unit to transmit the information collected by the controller to a data processing apparatus.

### CROSS-REFERENCE TO RELATED APPLICATION

This application claims the priority benefit of Korean Patent Application No. 10-2015-0100424, filed on Jul. 15, 2015 in the Korean Intellectual Property Office, the disclosure of which is incorporated herein by reference.

### BACKGROUND OF THE INVENTION

1. Field of the invention

The present invention relates to an electronic cigarette, a data processing apparatus, a method for measuring a smoking amount, and a smoking management system using the same which may efficiently manage smoking habits.

2. Description of the Related Art

An electronic cigarette is a sprayer which evaporates liquid containing nicotine concentrate or having only a tobacco scent. In contrast with a real cigarette which produces thousands of hazardous substances including tar and carbon monoxide, the electronic cigarette allows inhalation of pure nicotine alone and is thus considered to be less harmful to health than real cigarettes.

However, the electronic cigarette may prevent users from having healthy smoking habits. The concept of the number of cigarettes is not applied to the electronic cigarette compared to real cigarettes, and thus it is difficult to check how much the user smokes with the electronic cigarette. Thereby, the electronic cigarette may cause the user to smoke more than when real cigarettes are used. Further, with the electronic cigarette, the user experiences inconvenience in checking the battery charge and the amount of remaining liquid.

### SUMMARY OF THE INVENTION

Therefore, the present invention has been made in view of the above problems, and it is an object of the present invention to enhance user convenience in using an electronic cigarette and to allow a user to readily check the smoking amount.

Another object of the present invention is to provide a user of an electronic cigarette with information such as the smoking amount and the smoking interval and additional information related to the electronic cigarette such that the user can efficiently control the smoking habit.

Objects of the present invention are not limited to the aforementioned objects, and other objects of the present invention which are not mentioned above will become apparent to those having ordinary skill in the art upon examination of the following description and the accompanying drawings.

In accordance with an aspect of the present invention, the above and other objects can be accomplished by the provision of an electronic cigarette including a power unit to supply power, a liquid container to contain liquid, a heater to generate heat using power supplied from the power unit to evaporate the liquid contained in the liquid container, a sensor unit including a current sensor to measure a current supplied to the heater, a controller to collect information measured by the sensor unit, and a communication unit to transmit the information collected by the controller to a data processing apparatus.

The electronic cigarette may further comprise a timer to measure a duration from a time to begin supply of current to the heater to a time to stop supply of the current to the heater and a duration from the time to stop supply of the current to the heater to a time to resume supply of the current to the heater, and wherein the controller may further collect information associated with the time measured by the timer.

The controller may further collect information about the amount of power of the power unit.

The sensor unit may comprise at least one of a liquid level sensor to measure the amount of the liquid contained in the liquid container, a chemical sensor to measure an ingredient of the liquid contained in the liquid container, a motion recognition sensor to recognize motion of a user who uses the electronic cigarette, and the pressure sensor to measure an inhaling strength of the user for the evaporated liquid.

The communication unit may transmit the information collected by the controller to the data processing apparatus through wireless communication.

In accordance with another aspect of the present invention, there is provided a data processing apparatus including a communication unit to receive information about a current supplied in an electronic cigarette, and a calculator to calculate a smoking amount based on the received information.

The communication unit may further receive, from the electronic cigarette, information about a time for supply of the current, and wherein the calculator may calculate the amount of the current used by the electronic cigarette based on the information received by the communication unit, and calculate a smoking amount based on the calculated amount of current.

The communication unit may further receive, from the electronic cigarette, information about a duration from a time to begin supply of a current in the electronic cigarette to a time to stop supply of the current and a duration from the time to stop supply of the current to a time to resume supply of the current, and wherein the calculator may calculate a smoking interval based on the received information about the durations.

The data processing apparatus may further comprise a memory to store a smoking amount per a predetermined amount of a current, and wherein the calculator may calculate the smoking amount depending on the information received by the communication unit and the smoking amount per the predetermined amount of the current.

When the calculated smoking amount is larger than or equal to a predetermined smoking amount, the data processing apparatus may transmit a signal to the electronic cigarette via the communication unit.

The communication unit may further receive information about the amount of power of the electronic cigarette.

The communication unit may further receive information about the amount or an ingredient of liquid contained in a liquid container.

The data processing apparatus may further comprise a display unit to display at least one of one of the information received by the communication unit and the smoking amount calculated by the calculator.

In accordance with another aspect of the present invention, there is provided a method for measuring a smoking amount, including receiving, from an electronic cigarette, information about a current supplied in the electronic cigarette, and calculating the smoking amount based on the received information.

The calculating of the smoking amount may comprise calculating the amount of the current used by the electronic cigarette based on the current and a time for supply of the current, and calculating the smoking amount depending on the calculated amount of current and a smoking amount per a predetermined amount of a current.

The method may further comprise receiving, from the electronic cigarette, information about a time to begin supply of power in the electronic cigarette to a time to stop supply of the power and a duration from the time to stop supply of the power to a time to resume supply of the power, and calculating a smoking interval based on the received information about the duration.

The method for calculating the smoking amount may be implemented by a computer executable program and stored in a computer-readable storage medium.

In accordance with another aspect of the present invention, there is provided a smoking management system including an electronic cigarette, and a data processing apparatus to receive information from the electronic cigarette to calculate a smoking amount.

The electronic cigarette may comprise a power unit to supply power, a liquid container to contain liquid, a heater to generate heat using power supplied from the power unit to evaporate the liquid contained in the liquid container, a sensor unit including a current sensor to measure a current supplied to the heater, a controller to collect information measured by the sensor unit, and a first communication unit to transmit the information collected by the controller to the data processing apparatus.

The data processing apparatus may comprise a second communication unit to receive information from the electronic cigarette, a memory to store a smoking amount per a predetermined amount of a current, and a calculator to calculate the smoking amount based on the information received through the second communication unit and the smoking amount per a predetermined amount of a current.

When the smoking amount calculated by the calculator is larger than or equal to a predetermined smoking amount, the second communication unit may transmit a signal to the electronic cigarette, and wherein the electronic cigarette may comprise an alarm generator to generate an alarm according to the signal received from the data processing apparatus.

The second communication unit may transmit the information received from the electronic cigarette and the smoking amount calculated by the calculator to an external terminal.

According to an embodiment of the present invention, a user of an electronic cigarette may easily recognize the smoking amount.

According to an embodiment of the present invention, information such as the smoking amount and the smoking interval is provided to the user of the electronic cigarette. Thereby, the user may efficiently control the smoking habit.

It will be appreciated by persons skilled in the art that that the effects that can be achieved through the embodiments of the present invention are not limited to those described above and other effects of the present invention will be clearly understood from the following detailed description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating configuration of an electronic cigarette and a smoking management system according to an embodiment of the present invention;

FIG. 2 is a block diagram illustrating the data processing apparatus according to an embodiment of the present invention;

FIG. 3 is a graph depicting a method for calculating the smoking amount and the smoking interval according to an embodiment of the present invention;

FIGS. 4 and 5 are flowcharts illustrating a method for measuring the smoking amount according to an embodiment of the present invention; and

FIGS. 6 and 7 illustrate an electronic cigarette and a data processing apparatus provided to a user according to an embodiment of the present invention.

### DETAILED DESCRIPTION OF THE PREFERRED EMBODIMENTS

Advantages and features of the present invention and methods to achieve them will become apparent from the descriptions of exemplary embodiments herein below with reference to the accompanying drawings. However, the present invention is not limited to the exemplary embodiments disclosed herein, but may be implemented in various different forms. The exemplary embodiments are provided to make the disclosure of the present invention thorough and to fully convey the scope of the present invention to those skilled in the art. It is to be noted that the scope of the present invention is defined only by the appended claims. Throughout the specification, the same reference numbers will be used to refer to the same or like parts.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated compositions, components, constitutes, steps, operations, and/or devices, but do not preclude the presence or addition of one or more other compositions, components, constitutes, steps, operations, and/or devices. As used herein, the term “and/or” includes any and all combinations of one or more of the associated listed items.

As used herein, the suffixes “unit”, “device”, “block” and “module” may refer to a unit in which at least one function or operation is processed. For example, these terms may refer to software components or hardware component to such as field programmable gate array (FPGA) or application specific integrated circuits (ASIC). However, “unit”, “device”, “block” and “module” are not limited to software or hardware. The “unit”, “device”, “block” and “module” may be configured to be present on an addressable storage medium and configured to reproduce one or more processors.

Exemplary embodiments of the “unit”, “device”, “block” and “module” may be implemented by software or hardware components. The software component may comprise object-oriented software components, class components, and task components, and processes, functions, attributes, procedures, subroutines, segments of a program code, drivers, firmware, a micro code, a circuit, data, a database, data structures, tables, arrays, and variables. Functions provided by different components, “unit”, “device”, “block” and “module” may be combined into a smaller number of components, “units”, “devices”, “blocks” and “modules” or may be further separated into additional components, “units”, “devices”, “blocks” and “modules”.

According to an embodiment of the present invention, the electronic cigarette comprises a sensor unit and a communication unit. The sensor unit measures the amount of power and the amount of consumed currents, and the indication unit transmits the same to a data processing apparatus. By receiving and analyzing the information from the electronic cigarette, information such as the smoking amount and the smoking interval may be provided to the user. Thereby, the user may be allowed to efficiently manage the smoking habit.

Reference will now be made in detail to the preferred embodiments of the present invention, examples of which are illustrated in the accompanying drawings.

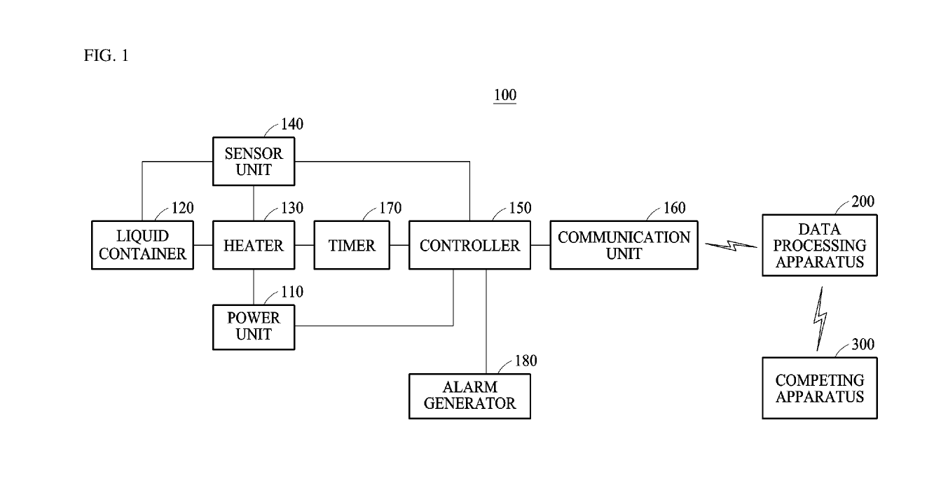

FIG. 1 is a block diagram illustrating an electronic cigarette 100 and a smoking management system according to an embodiment of the present invention.

As shown in FIG. 1, the electronic cigarette 100 may exchange information with a data processing apparatus 200 through communication. The data processing apparatus 200 may analyze information received from the electronic cigarette and provide the same to the user, or transmit the received information to a computing apparatus 300. Transmission and reception of information among the electronic cigarette, the data processing apparatus 200 and the computing apparatus 300 may be performed in accordance with a wireless communication scheme such as Bluetooth, Wi-Fi, near-field communication (NFC), or radio frequency (RF) communication. The data processing apparatus 200 may calculate the smoking amount based on the information received from the electronic cigarette 100. If the calculated smoking amount is larger than or equal to a predetermined smoking amount, data processing apparatus 200 may transmit a signal to the electronic cigarette 100. The electronic cigarette 100 may comprise an alarm generator 180 to generate an alarm according to the signal received from the data processing apparatus. The alarm generator 180 may comprise a light emitting diode (LED) and a vibration motor. Thereby, the alarm generator 180 may generate an alarm by emitting light or triggering vibration. However, the types of alarms which may be generated by the alarm generator 180 are not limited thereto. An alarm may be provided using any method enabling the user of the electronic cigarette to recognize the alarm.

The data processing apparatus 200 may be a device which is usually used by the user, for example, a smart phone. The computing apparatus 300 may be a device which is adjunctively used by the user, such as, for example, smart glasses, a smartwatch, a computer, a server, or the like. The computing apparatus 300 may be a device used by a third party other than the user. For example, the third party may receive information about the smoking amount of the user through the computing apparatus 300. It should be noted that the examples mentioned herein are for illustrative purpose, and the present invention is not limited thereto.

Referring back to FIG. 1, the electronic cigarette 100 may comprise a power unit 110, a liquid container 120, a heater 130, a sensor unit 140, a controller 150, and a communication unit 160. The heater 130 may generate heat using power supplied from the power unit 110. Thereby, the heater 130 may evaporate liquid contained in the liquid container 120. The sensor unit 140 may comprise a current sensor to measure a current supplied to the heater 130. The controller 150 may collect information measured by the sensor unit, and the communication unit 160 may transmit the information collected by the sensor unit 140 to the data processing apparatus 200. As mentioned above, the communication unit 160 may transmit the collected data to the data processing apparatus 200 in accordance with a wireless communication scheme such as Bluetooth, Wi-Fi, NFC, or the like.

The sensor unit 140 may further comprise a liquid level sensor to measure the amount of liquid contained in the liquid container 120, a chemical sensor to measure an ingredient of the contained liquid, a motion recognition sensor to recognize motion of the user who uses the electronic cigarette, or a pressure sensor to measure an inhalation strength of the user when inhaling the vaporized liquid. The motion recognition sensor may comprise at least one of an acceleration sensor, a gravity sensor and a gyro sensor.

The sensor unit 140 may further comprise a motion detection sensor such as an acceleration sensor, a gyro sensor and a conductive sensor and a sensor to sense an operation of manipulating the electronic cigarette. Herein, with a motion detection sensor such as an acceleration sensor or a gyro sensor, the direction in which the user lifts the electronic cigarette may be sensed through the degree of change of acceleration and change of a magnetic charge.

With a touch sensor, whether the user picks up the electronic cigarette or the lips of the user touch the inhaling port (not shown) of the electronic cigarette may be sensed by sensing a touch.

For example, if a piezoelectric sensor is provided to the inhaling port, a strength by which the user holds the electronic cigarette with mouth may be sensed, and the amount of the current supplied to the coil provided to the heater 130 may be controlled depending on the sensed strength. In other words, by sensing the intensity of smoking of the user through the sensor provided to the inhaling port, the amount of vapor generated by the heater 130 may be dynamically adjusted.

Thereby, the user using the electronic cigarette may naturally inhale the amount of smoke depending on the user's smoking habit. The controller 150 may further collect at least one of the amount of liquid measured by the liquid level sensor, information about ingredients of the liquid measured by the chemical sensor, information about motion of the user measured by the motion recognition sensor and information about the inhaling strength of the user measured by the pressure sensor. The controller 150 may further collect information about the amount of power of the power unit 110.

If the smoking amount is greater than or equal to a predetermined smoking amount, the communication unit 160 may receive a signal from the data processing apparatus. If the communication unit 160 receives the signal, the controller 150 may perform a control operation to stop operation of the heater 130. Meanwhile, when intention of the user to smoke is sensed by the sensor unit 140, the controller 150 may control the heater 130 to perform preliminary heating.

Herein, the intention of the user to smoke may correspond to at least one of lifting the electronic cigarette, moving the electronic cigarette close to the lips of the user and holding the electronic cigarette with mouth. The controller 150 may recognize the intention to smoke by sensing, through the motion detection sensor, the vertical level of the electronic cigarette exceeding a reference value. Recognition of the intention to smoke may be determined through an experiment of various movements.

Herein, the preliminary heating may not be an essential operation. If the preliminary heating is performed, more natural smoking may be provided.

The controller 150 may sense the intention to smoke by dividing the intention into multiple steps.

For example, the controller 150 may recognize a first step of moving the electronic cigarette close to the lips of the user, which is sensed through the motion detection sensor, and then a second step of sensing the user holding the electronic cigarette with mouth.

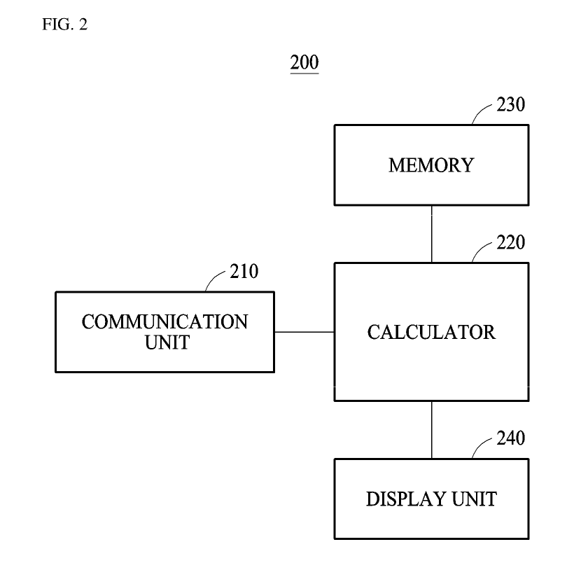

Referring back to FIG. 1, the electronic cigarette 100 may further comprise a timer 170 to measure a duration from the time to begin supply of current to the heater 130 to the time to stop supply of current and a duration from the time to stop supply of current to the time to resume supply of current. The controller 150 may further collect time information measured by the timer 170, and the communication unit 160 may transmit the collected time information to the data processing apparatus 200. The measured time information may be used to calculate the smoking amount or the smoking interval in the data processing apparatus 200. FIG. 2 is a block diagram illustrating the data processing apparatus 200 according to an embodiment of the present invention.

As shown in FIG. 2, the data processing apparatus 200 may comprise a communication unit 210 and a calculator 220. The communication unit 210 may receive information about a current used in the electronic cigarette. The calculator 220 may calculate the smoking amount based on the information received by the communication unit 210.

The communication unit 210 may further receive information about a time during which a current is supplied in the electronic cigarette, and the calculator 220 may calculate the smoking amount based on the information received by the communication unit 210. Even if the data processing apparatus 200 does not receive the information about the time during which the current is supplied from the electronic cigarette through the communication unit 210, the data processing apparatus 200 may receive information about the current from the electronic cigarette in real time, and calculate the smoking amount based on the time at which the information about the current is received by the data processing apparatus 200.

The communication unit 210 may further receive information about a duration from the time to begin supply of current to the electronic cigarette to the time to stop supply of current and a duration from the time to stop supply of current to the time to resume supply of current, and the calculator may calculate the smoking interval based on the received time information.

The communication unit 210 may further receive information about the amount of power of the electronic cigarette, information about the amount of the liquid contained in the liquid container of the electronic cigarette, or information about ingredients of the liquid contained in the liquid container of the electronic cigarette.

Referring back to FIG. 2, the data processing apparatus 200 may further comprise a memory 230 in which a smoking amount per a predetermined amount of a current is stored. The memory 230 may store the smoking amount per the predetermined amount of the current in the form of a lookup table, but the structure or type of the memory is not limited thereto. The calculator calculates the smoking amount based on the smoking amount per the predetermined amount of the current stored in the memory 230 and the information received by the communication unit 210.

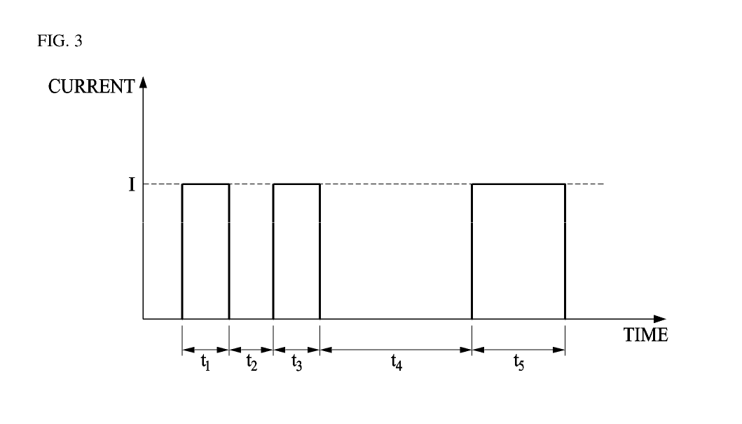

Hereinafter, a detailed description will be given of a method for calculating a smoking amount in the data processing apparatus 200 according to an embodiment of the present invention, with reference to FIG. 3.

The data processing apparatus 200 may receive the magnitude of a supplied current from the electronic cigarette via the communication unit 210. Referring to FIG. 3, the magnitude of current supplied in the electronic cigarette is I. The data processing apparatus 200 may further receive, via the communication unit 210, information about the time for which the current is supplied in the electronic cigarette. Referring to FIG. 3, the time for which the current is supplied in the electronic cigarette is t1+t3+t5.

The calculator 220 may calculate the amount of the current used in the electronic cigarette based on the information about the current and time received via the communication unit 210. In the example of FIG. 3, since the magnitude of the current supplied in the electronic cigarette is I, and the time for which the current is supplied in the electronic cigarette is t1+t3+t5, the calculator 220 may compute me×(t1+t3+t5) as the amount of a current used in the electronic cigarette.

The data processing apparatus 200 may further comprise a memory 230 in which a smoking amount per a predetermined amount of a current is stored. For example, it is assumed that information indicating that the amount of a current C corresponds to the smoking amount of one cigarette is stored in the memory 230. If the amount of the current calculated by the calculator 220 is I (t1+t3+t5), and is equal to the predetermined amount of current C (i.e., I×(t1+t3+t5)=C), the calculator 220 may calculate a smoking amount of one cigarette as the smoking amount.

Hereinafter, a detailed description will be given of a method for calculating a smoking interval in the data processing apparatus 200 according to an embodiment of the present invention, with reference to FIG. 3.

The data processing apparatus 200 may receive, via the communication unit 210, information about a duration from the time to begin supply of current in the electronic cigarette to the time to stop supply of current and a duration from the time to stop supply of current to the time to resume supply of current. In the example of FIG. 3, the communication unit 210 may receive time information about t1, t3 and t5 which are durations from a time to begin supply of current to a time to stop supply of current, and receive time information about t2 and t4 which are durations from a time to stop supply of current to a time to resume supply of current.

The calculator 220 may calculate a smoking interval based on the time information received through the communication unit 210. In the example of FIG. 3, the calculator 220 may determine that the user is smoking for the durations of t1, t3, and t5 during which a current is supplied in the electronic cigarette. The calculator 220 may determine that the user is not smoking for the durations of t2 and t4 during which supply of the current is stopped.

If the duration during which supply of the current is stopped is shorter than or equal to a predetermined time, the calculator 220 may determine that the user is smoking for the corresponding time. For example, in FIG. 3, if t2 is shorter than or equal to the predetermined time t (t2≦t), the calculator 220 may determine the user is smoking for t1+t2+t3, determining that the user is smoking for t2. If the time for which supply of current is stopped exceeds a predetermined time, the calculator may determine that the user is not smoking for the time. For example, in FIG. 3, if t4 exceeds the predetermined time t (t4>t), the calculator may determine t4 as the smoking interval, determining that the user is not smoking for t4.

The calculator 220 may calculate additional information such as an average smoking amount during a predetermined duration based on the received information, as well as the smoking amount and smoking interval.

Referring back to FIG. 2, the data processing apparatus 200 may further comprise a display unit 240.

The data processing apparatus 200 may display information received by the communication unit 210 from the electronic cigarette or the smoking amount calculated by the calculator 220. For example, the display unit 240 may display information about the amount of power received from the electronic cigarette, information about the amount of the liquid contained in the liquid container, or information about ingredients of the liquid contained in the liquid container. The display unit 240 may also display the smoking amount or smoking interval calculated by the calculator 220. The user may readily obtain information which is difficult to directly check in the conventional electronic cigarette, by checking the information displayed on the display unit 240.

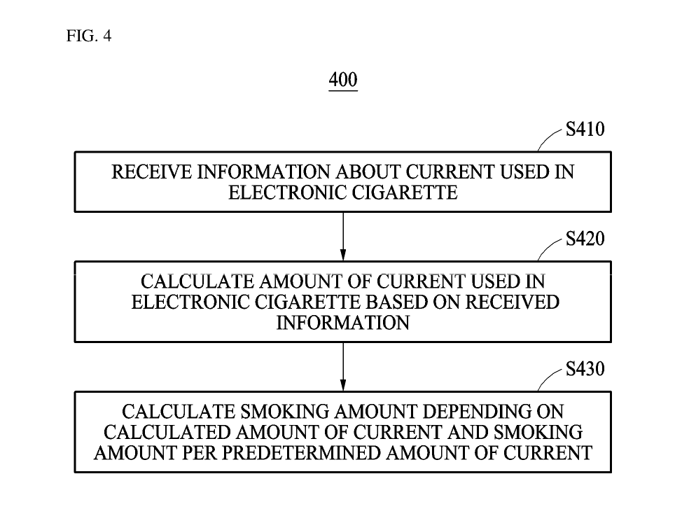

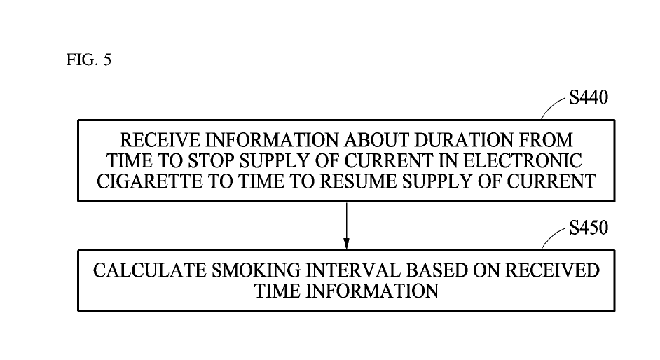

FIGS. 4 and 5 are flowcharts illustrating a method for measuring the smoking amount according to an embodiment of the present invention.

Referring to FIG. 4, the method 400 for measuring the smoking amount according to an embodiment of the present invention may comprise receiving, from an electronic cigarette, information about a current supplied in the electronic cigarette (S410), calculating the amount of the current used in the electronic cigarette based on the received information (S420), and calculating the smoking amount depending on the calculated amount of current and a smoking amount per the predetermined amount of the current (S430).

Specifically, in the calculating of the amount of the current used in the electronic cigarette (S420), the amount of the current used in the electronic cigarette may be calculated based on the current supplied in the electronic cigarette and the time for which the current is supplied. For example, when the current supplied in the electronic cigarette is I, and the time for supply of the current is t, I×t may be calculated as the amount of the current used in the electronic cigarette.

For example, if the calculated amount of current is I×t=C, and the smoking amount per the predetermined amount of the current corresponds to a one-cigarette smoking amount per current C, one cigarette may be calculated as the smoking amount in the calculating of the smoking amount (S430).

Referring to FIG. 5, the method 400 for measuring the smoking amount may comprise receiving, from the electronic cigarette, information about a duration from the time to begin supply of current in the electronic cigarette to the time to stop supply of the current and a duration from the time to stop supply of the current to the time to resume supply of the current (S440) and calculating a smoking interval based on the received information (S450). The reference numerals shown in FIG. 5 are for illustrative purpose, and are not intended to limit the sequential order of the operations.

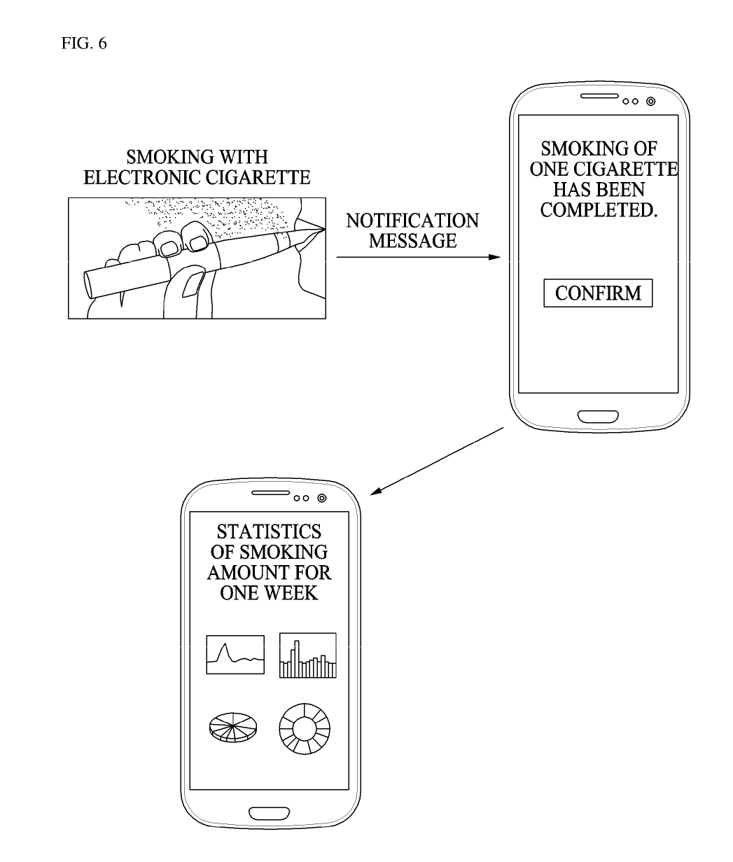

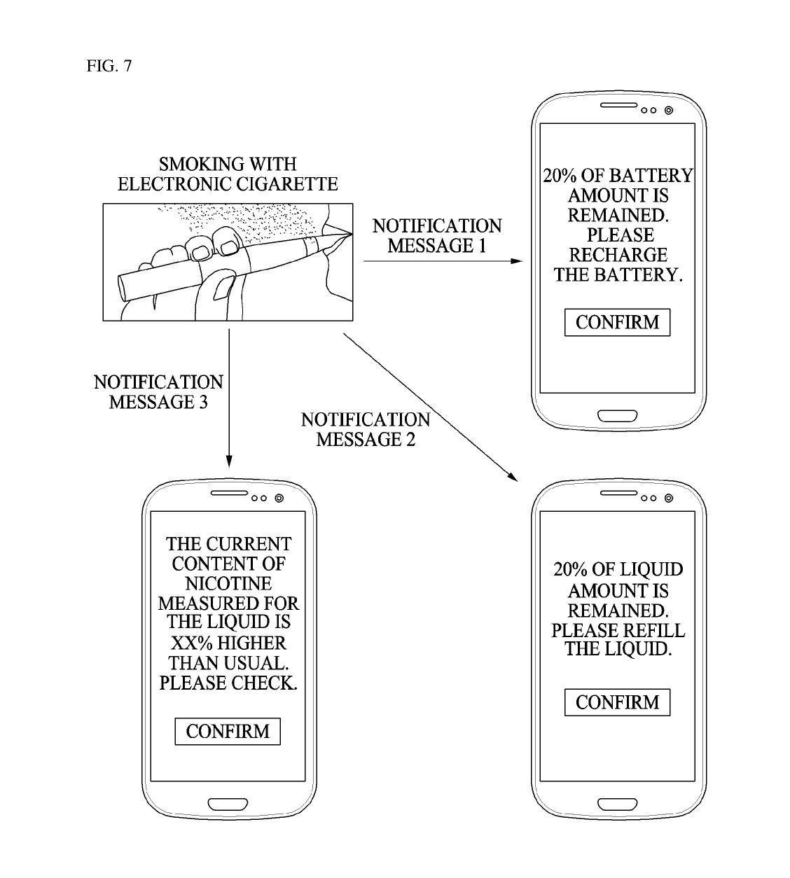

FIGS. 6 and 7 illustrate an electronic cigarette and a data processing apparatus provided to a user according to an embodiment of the present invention. The examples illustrated FIGS. 6 and 7 are intended to provide further understanding of the present invention, and are not intended to limit information that the data processing apparatus 200 according to an embodiment of the present invention can provide to the user.

Referring to FIG. 6, according to an embodiment, when a user uses the electronic cigarette 100, the data processing apparatus 200 may provide the user with information such as a notification message for the smoking amount indicating, for example, “Smoking of one cigarette has been completed” and statistics of the smoking amount for one week.

As the user uses the electronic cigarette 100, the data processing apparatus 200 may provide the user with additional information such as the amount of power, the amount of liquid, or the ingredients of the liquid in addition to the smoking amount. Referring to FIG. 7, the data processing apparatus 200 may provide the user with a notification message for the amount of power such as “20% of battery amount is remained. Please charge the battery”, a notification message for the amount of the liquid such as “20% of liquid amount is remained. Please charge the liquid”, a notification message for an ingredient of the liquid such as “The current content of nicotine measured for the liquid is XX% higher than usual. Please check”. Further, the data processing apparatus 200 may provide a screen image having a link to a website where the liquid can be purchased, along with a notification message for the amount of the liquid such as “The liquid level is 20%. Recharging is needed”.

Although specific embodiments of the present invention have been disclosed for illustrative purposes, those skilled in the art will appreciate that various modifications and variations can be made in the present invention without departing from the scope of the present invention. For example, constituents illustrated in the embodiments of the present invention may be implemented in in a distributed manner, or multiple distributed constituents may be combined to be implemented. Thus, it is to be understood that the invention is not limited to the embodiments disclosed herein, and is limited only by the appended claims and the equivalents thereof. The scope of protection sought by the present invention should be determined by the appended claims and their equivalents, and all changes coming within the meaning and equivalency range of the appended claims are intended to be embraced therein.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An electronic cigarette comprising:
a power unit to supply power;
a liquid container to contain liquid;
a heater to generate heat using power supplied from the power unit to evaporate the liquid contained in the liquid container;
a sensor unit comprising a current sensor to measure a current supplied to the heater;
a controller to collect information measured by the sensor unit; and
a communication unit to transmit the information collected by the controller to a data processing apparatus.

2. The electronic cigarette according to claim 1, further comprising:
a timer to measure a duration from a time to begin supply of a current to the heater to a time to stop supply of the current to the heater and a duration from the time to stop supply of the current to the heater to a time to resume the supply of the current to the heater, and
wherein the controller further collects information associated with the time measured by the timer.

3. The electronic cigarette according to claim 1, wherein the controller further collects information about the amount of power in the power unit.

4. The electronic cigarette according to claim 1, wherein the sensor unit comprises at least one of:
a liquid level sensor to measure the amount of the liquid contained in the liquid container;
a chemical sensor to measure an ingredient of the liquid contained in the liquid container;
a motion recognition sensor to recognize motion of a user who uses the electronic cigarette; and
a pressure sensor to measure an inhaling strength of the user for the evaporated liquid.

5. The electronic cigarette according to claim 1, wherein the communication unit transmits the information collected by the controller to the data processing apparatus through wireless communication.

6. A data processing apparatus comprising:
a communication unit to receive, from an electronic cigarette, information about a current supplied to a heater to heat liquid; and
a calculator to calculate a smoking amount based on the received information.

7. The data processing apparatus according to claim 6, wherein the communication unit further receives, from the electronic cigarette, information about a time for supply of the current, and
wherein the calculator calculates the amount of a current used by the electronic cigarette based on the information received by the communication unit, and calculates a smoking amount based on the calculated amount of the current.

8. The data processing apparatus according to claim 6, wherein the communication unit further receives, from the electronic cigarette, information about a duration from a time to stop supply of the current to a time to resume supply of the current, and
wherein the calculator calculates a smoking interval based on the information about the duration from the time to stop the supply of the current to the time to resume the supply of the current.

9. The data processing apparatus according to claim 6, further comprising:
a memory to store a smoking amount per a predetermined amount of a current,
wherein the calculator calculates the smoking amount depending on the information received by the communication unit and the smoking amount per a predetermined amount of the current.

10. The data processing apparatus according to claim 6, wherein, when the calculated smoking amount is larger than or equal to a predetermined smoking amount, the data processing apparatus transmits a signal to the electronic cigarette via the communication unit.

11. The data processing apparatus according to claim 6, wherein the communication unit further receives information about the amount of power in the electronic cigarette.

12. The data processing apparatus according to claim 6, wherein the communication unit further receives at least one of information about the amount or an ingredient of liquid contained in a liquid container of the electronic cigarette, information about motion of a user of the electronic cigarette and information about an inhaling strength of the user.

13. The data processing apparatus according to claim 6, further comprising:
a display unit to display at least one of the information received by the communication unit and the smoking amount calculated by the calculator.

14. A method for measuring a smoking amount, comprising:
receiving, from an electronic cigarette, information about a current supplied to a heater to heat liquid; and
calculating the smoking amount based on the received information.

15. The method according to claim 14, wherein the calculating of the smoking amount comprises:
calculating the amount of the current used by the electronic cigarette based on the current and a time for supply of the current; and
calculating the smoking amount depending on the calculated amount of the current and a smoking amount per a predetermined amount of a current.

16. The method according to claim 14, further comprising:
receiving, from the electronic cigarette, information about a duration from a time to stop supply of the current to a time to resume supply of the current; and
calculating a smoking interval based on the received information about the duration.

17. A computer-readable storage medium storing a computer executable program that, when executed, causes a computer to perform the method for measuring a smoking amount according to claim 14.

18. A smoking management system comprising:
an electronic cigarette; and
a data processing apparatus to receive information from the electronic cigarette to calculate a smoking amount,
wherein the electronic cigarette comprises:
a power unit to supply power;
a liquid container to contain liquid;
a heater to generate heat using power supplied from the power unit to evaporate the liquid contained in the liquid container;
a sensor unit comprising a current sensor to measure a current supplied to the heater;
a controller to collect information measured by the sensor unit; and
a first communication unit to transmit the information collected by the controller to the data processing apparatus,
wherein the data processing apparatus comprises:
a second communication unit to receive information from the electronic cigarette;
a memory to store a smoking amount per a predetermined amount of a current; and
a calculator to calculate the smoking amount based on the information received through the second communication unit and the smoking amount per the predetermined amount of the current.

19. The smoking management system according to claim 18, wherein, when the smoking amount calculated by the calculator is larger than or equal to a predetermined smoking amount, the second communication unit transmits a signal to the electronic cigarette, and
wherein the electronic cigarette comprises:
an alarm generator to generate an alarm according to the signal received from the data processing apparatus.

20. The smoking management system according to claim 18, wherein the second communication unit transmits the information received from the electronic cigarette and the smoking amount calculated by the calculator to a computing apparatus.
